(19) United States
(12) Patent Application Publication
(10) Pub. No.: US 2026/0310577 A1
(43) Pub. Date: Oct. 8, 2026

(54) IDENTITY GOVERNANCE ARTIFICIAL INTELLIGENCE AGENT

(71) Applicant: SailPoint Technologies, Inc., Austin, TX (US)

(72) Inventors: Philip James Ellis, Gates Mills, OH (US); Dawid Laszuk, Coquitlam (CA)

(21) Appl. No.: 19/642,465

(22) Filed: Apr. 8, 2026

Related U.S. Application Data
(60) Provisional application No. 63/785,019, filed on Apr. 8, 2025.

(51) Int. Cl. G06F 11/3604

(52) U.S. Cl. CPC G06F 11/3608

(57) ABSTRACT

Systems and methods for identity governance artificial intelligence agents are provided. Various embodiments of the present technology provide systems and methods for translating natural language queries into automated technical operations by routing them to specific internal tools. Embodiments include a system and method that uses a large language model (LLM) and validation logic in a recursive manner to overcome inconsistencies in machine-generated code objects. The system generates an initial code object, such as a workflow or transform, which is split into discrete steps that are evaluated individually against validation rules. If an invalid step is detected, a revised prompt containing the invalid step, the specific validation error, and contextual dependent steps is recursively sent to the LLM for correction. This iterative loop continues until a fully functional code object is assembled.

### CROSS-REFERENCE TO RELATED APPLICATION(S)

This application claims the benefit of priority under 35 U.S.C. § 119(e) from U.S. Provisional Application No. 63/785,019, filed Apr. 8, 2025, entitled “IDENTITY GOVERNANCE ARTIFICIAL INTELLIGENCE AGENT,” which is fully incorporated by reference herein for all purposes.

### TECHNICAL FIELD

This disclosure relates generally to Identity Governance and Administration (IGA) systems. In particular, this disclosure relates to systems and methods for utilizing artificial intelligence agents and large language models that provides automated execution of complex identity governance operations based on natural language prompts. Even more specifically, this disclosure relates to a recursive workflow builder that generates and individually validates machine-generated code objects by splitting them into discrete functional steps for recursive evaluation and correction.

### BACKGROUND

Identity Governance and Administration (IGA) is crucial IT technology that enables and secures digital identities for users, applications and data. IGA allows organizations to provide automated access to an ever-growing number of technology assets while managing potential security and compliance risks. IGA systems manage digital identities and access permissions to ensure that individuals have proper access to resources and can be used to maintain compliance with an organization's policies and legal requirements.

An IGA system can implement workflows for identity management (creating, updating, and deletion of identities) and access management (assigning and removing permissions (e.g., based on changes in responsibility) among others). An IGA system may, for example, have workflows for individuals joining an organization, individuals moving within the organization (e.g., promotion, demotion, reassignment), and individuals leaving the organization. Due to the large number of individuals, roles, permissions, resources, capabilities, APIs, etc. in an IGA system, creating new workflows, generating complex search queries, and answering questions about how to perform specific IGA actions is unintuitive, complicated, time consuming, and error prone for many users. Traditionally, these operations are manually derived, requiring administrators to rely on dense technical documentation and complex manual processes. Furthermore, because administrators typically rely on their own limited system knowledge, the workflows they manually create often utilize inefficient execution paths. These inefficient manual workflows unnecessarily consume excess server compute time and incur higher service costs compared to optimized operational paths.

Therefore, there is a need for an intelligent identity governance system that provides automated execution of complex operations based on natural language inputs. Furthermore, there is a need for a solution that provides computationally optimized workflows and search queries to eliminate the burden of manual documentation review, minimize excess server compute time, and lower overall system costs.

### SUMMARY

Methods are described that operate an identity governance artificial intelligence agent by receiving, via a user interface, a natural language prompt from a user to perform an identity governance operation. The natural language prompt is processed using a large language model to generate an initial code object for executing the identity governance operation. The initial code object is then split into a plurality of discrete steps. A first discrete step of the plurality of discrete steps is evaluated against step-specific validation rules to determine whether the first discrete step is valid. Responsive to determining that the first discrete step is invalid based on a validation error, a revised prompt is automatically generated that includes the invalid first discrete step, the validation error, and contextual information from the initial code object. The revised prompt is transmitted to the large language model to generate an updated first discrete step. This first discrete step is iteratively evaluated and updated until valid and then combined with other valid discrete steps of the plurality of discrete steps to output a fully validated code object for the identity governance operation.

In some embodiments, systems are described that include one or more processors and a non-transitory computer-readable memory storing instructions that, when executed by the one or more processors, cause the identity governance computer system to operate an identity governance artificial intelligence agent. The system receives, via a user interface, a natural language prompt from a user to perform an identity governance operation. The natural language prompt is processed using a large language model to generate an initial code object for executing the identity governance operation. The initial code object is then split into a plurality of discrete steps. A first discrete step of the plurality of discrete steps is evaluated against step-specific validation rules to determine whether the first discrete step is valid. Responsive to determining that the first discrete step is invalid based on a validation error, the system automatically generates a revised prompt comprising the invalid first discrete step, the validation error, and contextual information from the initial code object. The revised prompt is transmitted to the large language model to generate an updated first discrete step. The first discrete step is iteratively evaluated and updated until valid and then combined with other valid discrete steps of the plurality of discrete steps to output a fully validated code object for the identity governance operation.

In some embodiments, non-transitory computer-readable media are described that store instructions that, when executed by one or more processors of an identity governance computer system, cause the identity governance computer system to receive, via a user interface, a natural language prompt from a user to perform an identity governance operation. The instructions further cause the system to process the natural language prompt using a large language model to generate an initial code object for executing the identity governance operation and split the initial code object into a plurality of discrete steps. A first discrete step of the plurality of discrete steps is evaluated against step-specific validation rules to determine whether the first discrete step is valid. Responsive to determining that the first discrete step is invalid based on a validation error, a revised prompt is automatically generated that includes the invalid first discrete step, the validation error, and contextual information from the initial code object. The revised prompt is transmitted to the large language model to generate an updated first discrete step. The instructions cause the system to iteratively evaluate and update the first discrete step until valid and combine the valid first discrete step with other valid discrete steps of the plurality of discrete steps to output a fully validated code object for the identity governance operation.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a flowchart illustrating a user interface flow for an artificial intelligence agent routing identity governance operations.

FIG. 2 is a flowchart illustrating an automated tool selection and routing process performed by the artificial intelligence agent.

FIG. 3 is a flowchart illustrating a recursive code object creation and validation process.

FIG. 4 shows a user interface start screen for interacting with the artificial intelligence agent.

FIGS. 5-6 show user interface screens illustrating an automated search operation based on a user query and subsequent navigation to the search results.

FIGS. 7-9 show user interface screens illustrating the generation, creation, and visual display of a new identity governance workflow based on a natural language prompt.

FIG. 10 is a block diagram illustrating an exemplary hardware architecture of a computer system for implementing the described identity governance embodiments.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

### High-Level System Overview & AI Agent Introduction

According to the present disclosure, an IGA system can include artificial intelligence (AI) agents that take user input, IGA data and other relevant information and use a large language model (LLM) and other resources to deliver insights and contextual support through natural language prompts, enabling decision making, information discovery and task completion. An AI agent can simplify normally complex IGA tasks through the use of an LLM, response-augmented generation (RAG) techniques and internal and/or customer data to navigate an IGA system on behalf of the user.

Embodiments can use generative AI to provide a conversational AI interface wherein admins can create, modify, or describe workflows based on natural language. The AI agent can prompt the user in a particular sequence/using certain keywords, use the user's natural language requests and other data to create engineered prompts to the LLM engineered so that the AI agent provides an output (e.g., Workflow, Certification, Policy etc.) that is useful to the user.

Another aspect of the present disclosure includes displaying and acting on user input in the form of message prompts as well as actional IGA items. Embodiments may include ingesting a message prompt from a user and identifying if that prompt can be translated into additional actions that can be chained together to perform advanced IGA tasks.

According to another aspect of the present disclosure, an AI agent uses an LLM to select tools for servicing user queries. In some embodiments, the AI agent returns an indication of a suggested tool to the user for selection. In addition, or in the alternative, the AI agent automatically issues calls to selected tools to execute IGA processes.

Another aspect of the present disclosure includes an AI agent identifying security documentation across multiple products and platforms. An AI agent document tool can provide rapid, AI-driven responses, delivering relevant documentation with source links, as well as answering specific questions about how to perform specific actions in the identity governance platform. This can significantly reduce time security professionals spend manually searching through dense technical resources to manually derive workflows or search queries, allowing teams to resolve issues faster and enforce best practices more effectively.

Another aspect of the present disclosure includes a workflow builder that uses AI to generate optimized workflows and other code objects, such as transforms, with recommendations. For example, an AI agent can use an LLM and validation logic in a recursive manner to create workflows or transforms and refine invalid workflows or transforms into valid workflows or transforms. The AI agent overcomes inconsistencies in LLM generated code by using validation logic, auto generated prompts, and recursion to incrementally refine a large code set into more easily understood prompts and logic. Embodiments may further improve LLM single shot success rates for generating workflow and transform logic. From a user's perspective, this recursive validation allows for a “single-shot” interaction where a single natural language request results in a fully functioning, validated object.

The LLM or processes of using the LLM may be refined for use with IGA by various techniques such as, but not limited to: training the LLM using domain specific texts (e.g., product documents, API specifications or other relevant documents); vector embedding a knowledge base to allow retrievals based on a similarity search to information identified by the LLM; using retrieval augmented generation (RAG) in which the IGA does an initial search for relevant information from a knowledge base and provides the relevant information as context as part of the prompt; or few-shot learning in which examples are provided within the prompt.

For the sake of example, some embodiments of AI Agents are described in the context of identity governance solutions by SailPoint Technologies, Inc. including, for example, SailPoint Identity Security Cloud (all trade names, trademarks, service marks and the like used herein are the property of their respective owners). However, one of ordinary skill in the art will appreciate that embodiments may be adapted to various platforms.

### User Interface Flow for Operations

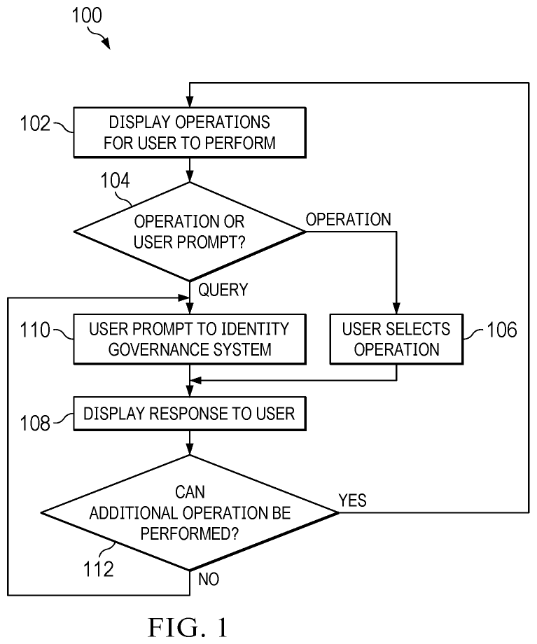

Turning to FIG. 1, one embodiment of a user interface (UI) flow 100 for a conversational AI agent is illustrated. Flow 100 may be implemented using software, hardware or a combination of software and hardware. In some embodiments, flow 100 may be embodied as computer code on a non-transitory computer medium, where the code is translatable by a processor to perform steps of flow 100. Flow 100 may be performed by an exemplary system such as by applications or services that run on one or more servers. However, flow 100 is not limited to such examples.

At step 102, the UI displays operations for the user to perform and includes a control (e.g., text box) to allow the user to submit a query. For example, the UI may display an initial set of operations from which the user can select. In another embodiment, the user asks the AI agent a question and the agent may return several options that the user can perform based on the user's question. Thus, at step 104, an input is received. The user input may, for example, indicate the selection of an operation by the user (e.g., the user clicks on a displayed operation) or a conversational prompt entered by the user. If the input indicates selection of an operation, the IGA platform executes the user selected operation (step 106) and returns a response (step 108).

If the input is a user prompt, the AI agent, at step 110, processes the user prompt to generate an engineered prompt to the LLM. In some embodiments, the LLM returns a suggested IGA tool for servicing the query and a query for the IGA tool. The AI agent may return an indication of the suggested tool (step 106) for selection by the user. In other embodiments, processing the user prompt at step 110 may include the agent automatically using the tool to carry out an operation. The selected tool may also use the LLM to perform an operation, such as creating a workflow, searching for and summarizing relevant documentation with source links, etc.

At step 112, a determination is made whether the user input can be mapped to additional operations (e.g., if the prompt can be translated into additional actions that can be chained together to perform advanced IGA tasks). For example, the AI agent may include rules for common scenarios that specify suggested next steps depending on the result from step 208. For example, if a workflow was created, an additional step could be “Do you want to view the workflow?” As another example, if a role is created, the additional step could be “Do you want to assign the role?” If an additional action can be chained (as determined at step 112), the suggested operations are displayed to the user for selection. If there are no actions that can be chained (as determined at step 112), the system can wait for the next prompt from the user. Flow 100 can continue until an end condition is met.

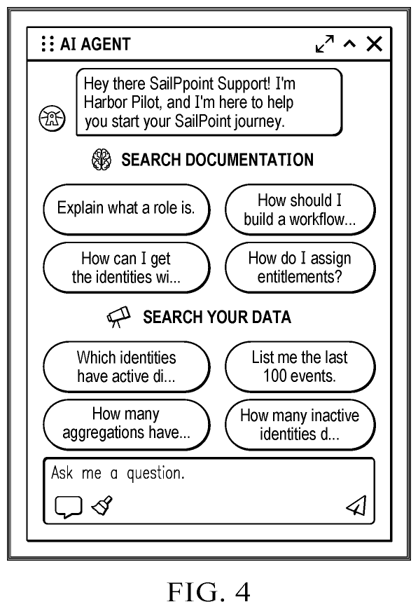

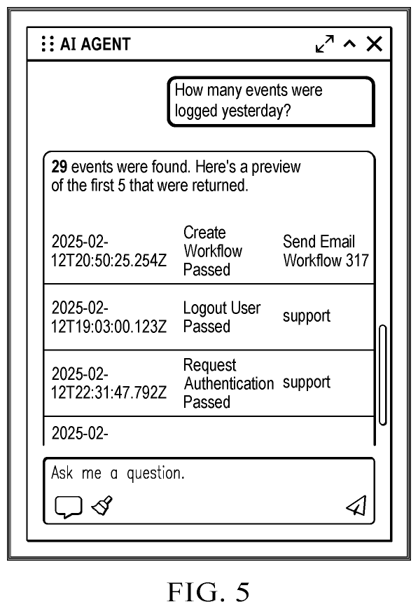

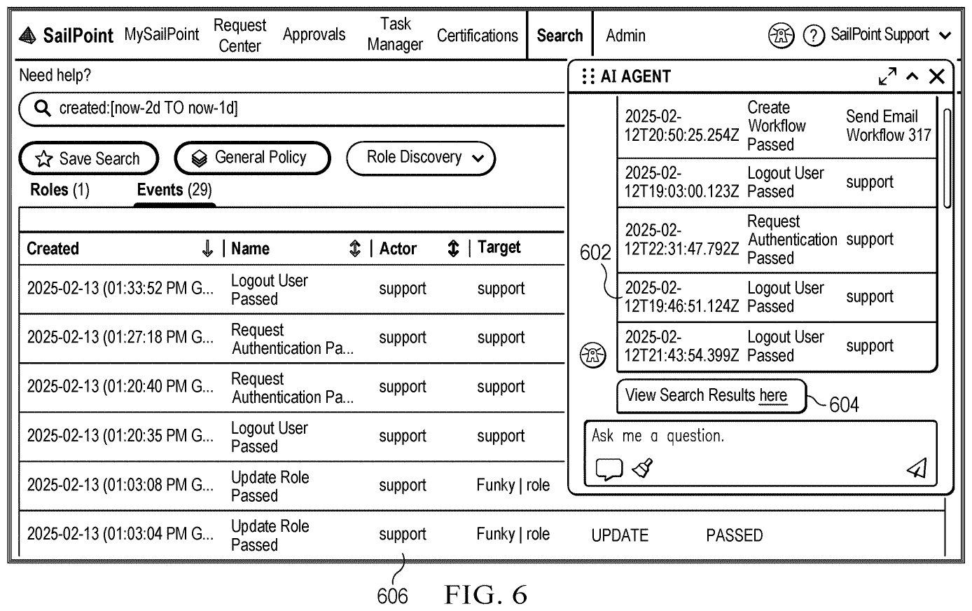

As one example, an initial AI agent UI screen may be displayed that includes several operations on which the user can click and a conversational chat text box in which the user can enter a natural language query (step 102). (See, FIG. 4). The user may enter a query “How many events were logged yesterday?”, which is received at step 104. (See, FIG. 5). At step 106, the AI agent uses the LLM to generate a query for an admin_search tool and summarize the results, which, at step 108, the AI agent displays to the user. (See, FIG. 5 and FIG. 6 (e.g., answer 602)). The AI agent also determines that a possible next action after a search is to view the search (step 112) and displays the suggested next action 604, “View Search Results here”, in the UI (step 102), where the “View Search Results here” option is linked to the search results. (See, FIG. 6). The user clicks on the “View Search Results here” option and, as such, an input is received at step 104. The system processes the input (step 106) to display the search results 606 in the overall IGA UI. (See, FIG. 6).

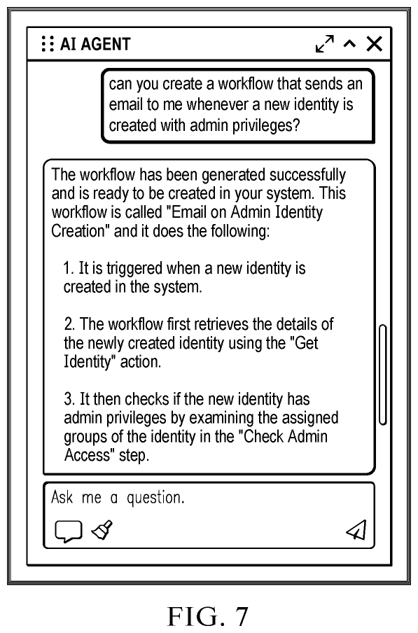

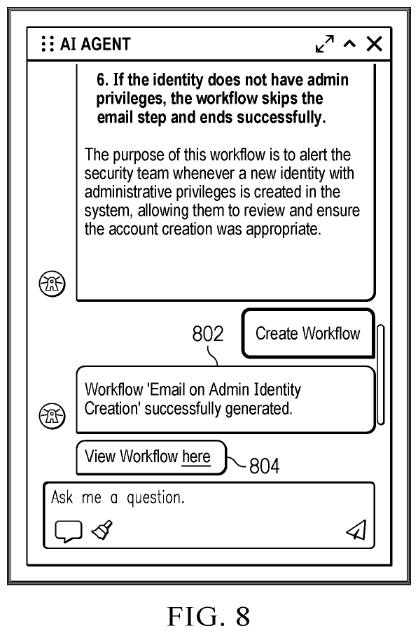

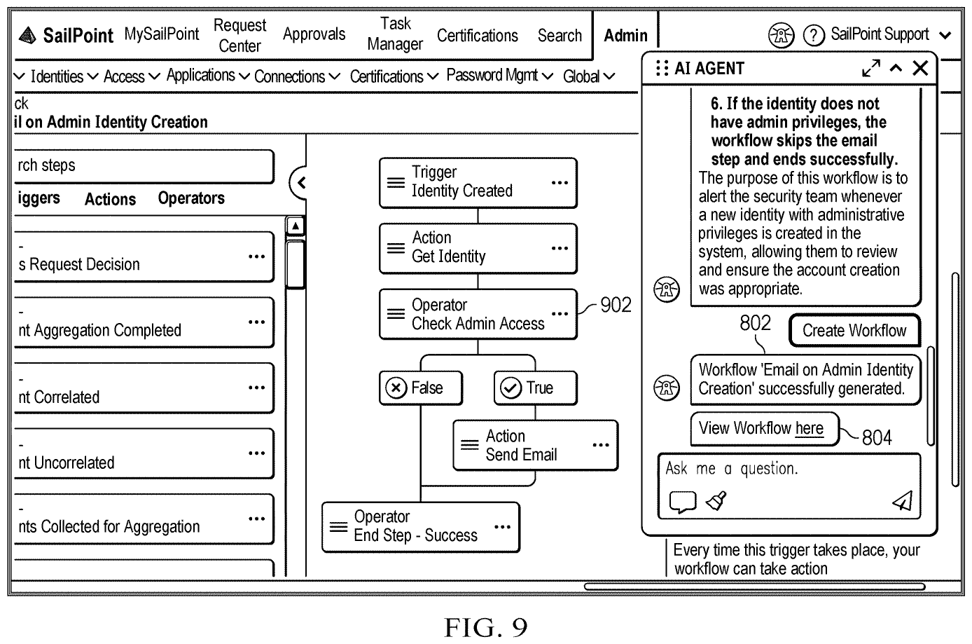

As another example, the user may enter a query “can you create a workflow that sends an email to me whenever a new identity is created with admin privileges?” in the conversational AI agent UI presented at step 102 and thus, the AI agent receives the query at step 104. (See, FIG. 7). The query is processed at 110 using an LLM to determine that a workflow builder tool is available for building workflows and to return the identity governance operations that are going to be performed in the workflow, which can be displayed to the user (step 108). (See, FIG. 7 and FIG. 8). In this example, the user enters “Create Workflow,” which is received at step 104, and the AI agent processes the prompt (step 110) to invoke the workflow builder to build the workflow. The AI Agent returns a response 802 of “Workflow ‘Email on Admin Identity Creation’ successfully generated” (step 108). (See, FIG. 8 and FIG. 9). Further, the AI Agent determines that a next step after building a workflow is to view the workflow (step 112) and thus displays a “View Workflow here” option 804 in the UI (step 102) linked to the workflow that was built (e.g., by workflow id). (See, FIG. 8 and FIG. 9). The user clicks on the “View Workflow here” option 804 and, thus, the AI agent receives the indication of the operation at step 104. The AI agent executes the operation to cause the workflow 902 to be displayed in the overall UI. (See, FIG. 9).

FIG. 1 is merely an illustrative example, and the disclosed subject matter is not limited to the ordering or number of steps illustrated. Embodiments may implement additional steps or alternative steps, omit steps, or repeat steps.

### Automated Tool Selection and Routing Flow

An IGA system may offer multiple tools for performing IGA tasks. According to another aspect of the present disclosure, the AI agent can process a user's natural language query using an LLM to guide the user in selecting an IGA tool to use. Further, in some embodiments, the AI agent may automatically generate queries to the identified tools.

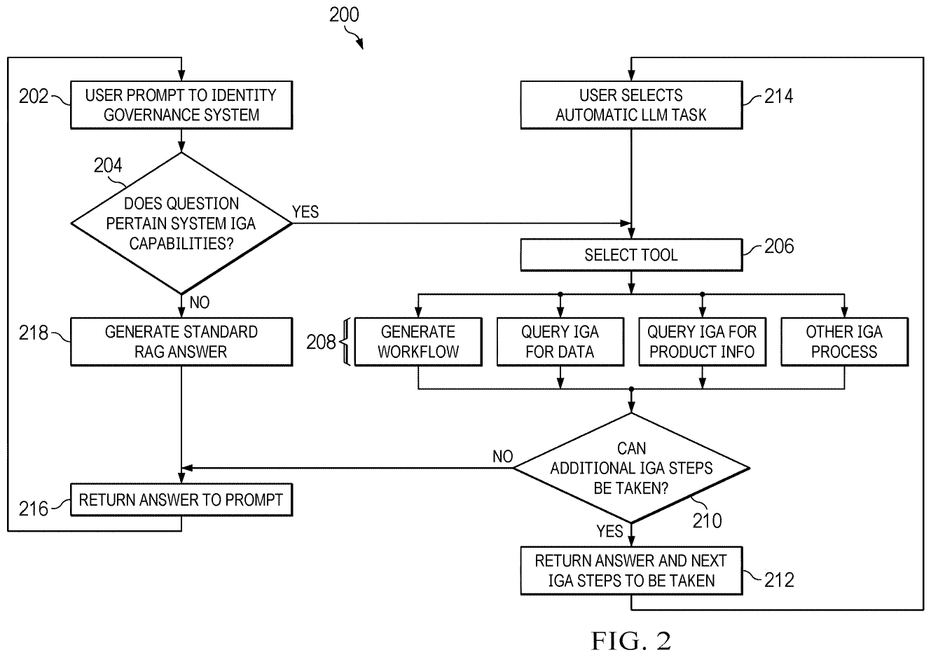

Turning to FIG. 2, one embodiment of a flow 200 for AI agent assisted routing is illustrated. Flow 200 may be implemented using software, hardware or a combination of software and hardware. In some embodiments, flow 200 may be embodied as computer code on a non-transitory computer medium, where the code is translatable by a processor to perform steps of flow 200. Flow 200 may be performed by an exemplary system such as by applications or services that run on one or more servers. However, flow 200 is not limited to such examples.

A user prompt is received by the AI agent (step 202). The user prompt may include a natural language query from the user. The AI agent processes the query using the LLM to determine if the user's query is related to a supported IGA tool (step 204). If so, the LLM returns an indicator of the appropriate tool and, in some embodiments, an LLM generated query to provide to the tool. According to one embodiment, the AI agent presents the identified tool to the user for selection and, if the user selects the tool, provides the LLM generated query to the tool. In other embodiments, the AI agent selects the tool indicated by the LLM (step 206) and generates a call to the API of the selected tool (step 208) to submit the LLM generated query to cause the tool to carry out the IGA process. In the embodiment illustrated, the AI agent may, for example, issue calls to generate a workflow, query the IGA system for IGA data (e.g., information related to identities, roles, entitlements, privileges, access profiles, audit events, and administrative information), query the IGA system for product information (e.g., product documentation), or execute other IGA processes, such as, but not limited to creating certificate campaigns. The IGA tool selected may itself use the LLM or other AI when servicing the queries. In any case, the AI agent receives responsive data returned by the tool (e.g., pointer to the workflow and workflow metadata, search results, etc.).

In some embodiments, the AI agent determines if additional IGA steps are to be taken (step 210). For example, the AI agent may include rules for common scenarios that specify suggested next steps depending on the result from step 208. For instance, if a workflow is created, an additional step could be “Do you want to view the workflow?” As another example, if a role is created, the additional step could be “Do you want to assign the role?” If additional IGA steps are determined, the AI agent returns an answer that includes, for example, data returned by the IGA tool and the additional steps to be taken (step 212). The user may then select one of the additional steps (step 214). If no additional steps are to be taken, the AI agent returns an answer to the prompt (step 216) based on the data returned by the selected IGA tool.

If, at step (204), the AI agent determines that the query is not related to a supported IGA tool, the AI agent generates a retrieval-augmented generation (RAG) answer to the user's query (step 218). The AI agent, for example, may use the LLM to search for and summarize or otherwise process responsive data to generate the answer to the user's prompt. At step 216, the AI agent returns the answer to the query (step 216).

As discussed, the AI agent can select a tool and generate calls to the tool based on a prompt from a user. In some embodiments, the AI agent provides a prompt to the LLM that includes the user query and examples for few-shot learning. Appendix A, for example, includes prompt data for several example tools including tools that pertain to system IGA capabilities (e.g., an admin_search tool, a workflow_builder tool, a sailpoint_doc tool) and a fallback_tool for addressing other queries. When the user prompt is received at step 202, the AI agent generates an engineered prompt to the LLM where the engineered prompt includes the user prompt and the data of Appendix A. Consequently, the LLM will return an output that indicates the appropriate tool (e.g., admin_search, workflow_builder, sailpoint_doc, fallback_tool) or none_selected and a corresponding query or flag. Thus, for example, step 204 and step 206 may be carried out using the LLM. If the LLM returns admin_search, workflow_builder, or sailpoint_doc as the tool to use, the AI agent issues the LLM generated query to the tool (step 208). If the LLM indicates the fallback_tool and a corresponding query or flag, the AI agent submits the query or flag to the fallback_tool to generate a response (step 218). If the LLM agent returns none_selected, the AI agent may return an indicator that the prompt was rejected or that no tool matches the query.

In some embodiments, the tools themselves utilize the LLM to perform various functions. For example, the admin_search tool may use the LLM to translate an input query into elastic search queries to a database and summarize, format, or otherwise process data returned in response to the queries to return an answer. The sailpoint_doc may use the LLM to identify and return relevant documentation from a knowledge base with source links. The workflow_builder tool may use the LLM to generate a workflow. The fallback_tool may use the LLM to provide RAG answers to queries.

As one example, an initial AI agent UI screen may be displayed that includes several operations on which the user can click and a conversational chat text box in which the user can enter a natural language query. (See, FIG. 4). The user may enter a query “How many events were logged yesterday?”, which is received at step 204. (See, FIG. 5). The AI agent uses the LLM to determine that admin_search tool should be used for the query and to generate a query for the tool (step 204 and step 206) and issues the generated query to the tool (step 208). The LLM processes the query to issue elastic search queries to a data store and summarizes the results and provides pointers to the search results to the AI agent. The AI agent determines that a next action after a search is to view the search (step 210) and thus returns the results 602 with the additional IGA action 604, “View Search Results here”, for display in the agent UI (step 212). The user clicks on the “View Search Results here” option and the agent processes the input to retrieve and display the search results 606 in the overall IGA UI. (See, FIG. 6).

As another example, the user may enter a query “can you create a workflow that sends an email to me whenever a new identity is created with admin privileges?” in the conversational AI agent UI and thus, the AI agent receives the query at step 202. (See, FIG. 7). The query is processed using an LLM to determine that a workflow builder tool is available for building workflows (steps 204 and step 206) and a query is provided to the workflow builder. The workflow builder returns the identity governance operations that are going to be performed in the workflow. (See, FIG. 7 and FIG. 8) and a response is returned to the user (step 216).

In this example, the user enters “Create Workflow,” which is received at step 204, and the AI agent processes the prompt to invoke the workflow builder to build the workflow (step 204, step 206, step 208). The workflow builder builds the workflow and returns a pointer to the workflow to the AI agent. The AI Agent determines that a next step after building a workflow is to view the workflow (step 210) and thus returns a response 802 of “Workflow ‘Email on Admin Identity Creation’ successfully generated” and option 804 of “View Workflow here” in the UI, where option 804 linked to the workflow that was built (e.g., by workflow id). (See, FIG. 8 and FIG. 9). The user clicks on the “View Workflow here” option 804 (step 214) and the AI agent executes the operation to cause the workflow 902 to be displayed in the overall UI. (See, FIG. 9).

FIG. 2 is merely an illustrative example, and the disclosed subject matter is not limited to the ordering or number of steps illustrated. Embodiments may implement additional steps or alternative steps, omit steps, or repeat steps.

### Recursive Code Object Builder Execution Loop

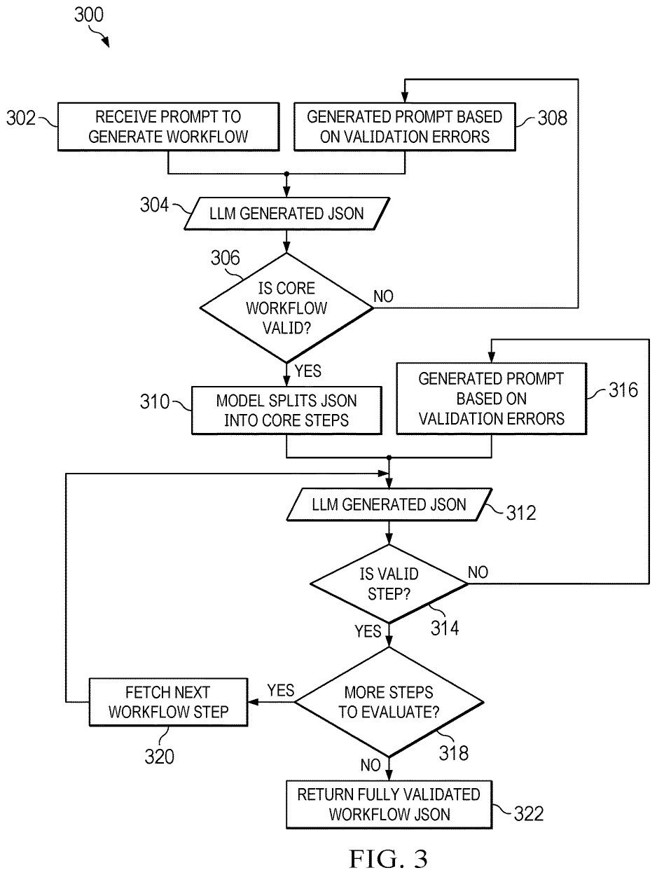

Turning to FIG. 3, one embodiment of a flow 300 for an AI workflow builder is illustrated. While described in the context of generating workflows, the recursive validation processes of flow 300 can similarly be applied to other code objects within the identity platform, such as transforms. Flow 300 may be implemented using software, hardware or a combination of software and hardware. In some embodiments, flow 300 may be embodied as computer code on a non-transitory computer medium, where the code is translatable by a processor to perform steps of flow 300. Flow 300 may be performed by an exemplary system such as by applications or services that run on one or more servers. However, flow 300 is not limited to such examples.

At step 302, a prompt to create a workflow is received where the prompt comprises an input query. The query may comprise a user query or a system generated query, such as a query generated by an LLM from a user query. The workflow builder generates an engineered prompt to the LLM where the engineered prompt includes relevant context and, in some embodiments, examples for few-shot learning. The engineered prompt is engineered to cause the LLM to analyze a corpus of documentation for workflows in the IGA system (e.g., workflow guides, API documents, etc. for workflows in the IGA platform) and then generate what the LLM determines to be the best, most appropriate workflow based on that question. According to one embodiment, the workflow builder generates an engineered prompt to the LLM where the engineered prompt includes the relevant query and a prompt template. One example embodiment of a workflow prompt template is provided in Appendix B. In addition to the prompt, references to documents and details of and rules for generating workflows based on the particular platform for which the workflow builder is creating workflows are provided.

The LLM interacts with the APIs of the IGA system according to the engineered prompt to build an initial workflow defined, for example, by a JSON object 304. Appendix C provides an example embodiment of an initial workflow.

At step 306, the workflow builder applies core validation rules to the workflow to determine if the core workflow is valid. For example, the workflow builder validates that the overall structure of the JSON object is valid, such as determining that the JSON object includes the fields required by the system for all workflows. If the core workflow cannot be validated, the AI agent generates prompts to the LLM based on the validation errors (step 308) and the LLM updates the JSON object 304 to correct the errors. For example, the workflow builder can prompt the LLM to add a required workflow field to the workflow. The workflow builder may include, with the prompt, the entire workflow and the input query for context.

Once the core workflow has been validated, the individual steps are validated. Thus, the workflow builder splits the JSON into workflow steps (step 310) embodied as JSON objects 312. At step 314, the JSON 312 for a workflow step is selected and a validation rule for the step is applied. For example, for an e-mail step, the workflow builder may determine that the email step is missing a subject.

If the workflow step is not valid, the workflow builder generates prompts to the LLM based on the validation errors (step 316) to cause the LLM to update the workflow step. For example, the workflow builder can prompt the LLM to add a subject field to the email step. The workflow builder may include, with the prompt, the invalid step, the specific validation error, the entire workflow, surrounding dependent workflow steps, and the input query for context. By keeping the evaluated data and surrounding context within the LLM's optimal context window, the system increases the accuracy of the LLM's corrections.

When the updated step is returned, the workflow builder can apply the validation rules to the step. This can be repeated until the step is determined to be valid. If the workflow step is valid (as determined at step 314), a determination is made whether there are more workflow steps to validate (step 318) and, if so, the next workflow step is fetched (step 320) and validated (step 314). When all the steps have been processed, the fully validated workflow JSON is returned (step 322).

FIG. 3 is merely an illustrative example, and the disclosed subject matter is not limited to the ordering or number of steps illustrated. Embodiments may implement additional steps or alternative steps, omit steps, or repeat steps.

The splitting and individual validation technique described in flow 300 provides a significant technical and computational advantage to the identity governance system. Because human administrators typically rely on their own limited system knowledge when manually deriving workflows, human-generated workflows often utilize inefficient execution paths. In contrast, the AI workflow builder utilizes its comprehensive access to system documentation and recursive validation logic to automatically select the most efficient operational paths. Consequently, the resulting machine-generated workflows are computationally optimized to execute more efficiently on backend servers, minimizing excess server compute time and reducing overall system and service costs compared to manually drafted workflows.

### Application User Interface Examples

FIG. 4 illustrates a user interface (UI) start screen for an AI Agent in which a user can enter a query. The AI agent UI includes example prompts operations (Search Documentation, Search Your Data) and suggested queries.

FIG. 5 illustrates an example in which the user has entered the prompt “How many events were logged yesterday?” (step 202). The AI Agent uses the LLM to process the prompt to return an indication that the admin_search tool should be used and a query for the admin_search tool (step 204, step 206). The AI agent sends the prompt to the admin_search tool (step 208), which uses the LLM fetches and summarize requested data from the IGA system. The AI agent determines that a next action after an admin_search is to “View Search Results”, creates a link for viewing the search results and returns the answer from the LLM and a “View Search Results” action to the user (step 218). Thus, the user may click on the “View Search Results” option in the UI to see the search results in their browser. FIG. 6, for example, illustrates an example in which the AI agent has returned a result 602 and next IGA next step 604 (e.g., “View Search Results Here”) and the user has selected to view the search results such that the search results 606 appear in the overall UI.

FIG. 7 illustrates an example of the AI Agent UI in which the user has submitted the query, “can you create a workflow that sends an email to me whenever a new identity is created with admin privileges?”. The AI agent causes the workflow to be generated and returns metadata and information about the generated workflow. In FIG. 8, the user enters the prompt “Create Workflow” and the AI agent causes the workflow to be created, returns a response 802 indicating that the workflow has been created, and includes a next step 804, “View Workflow here”. FIG. 9, for example, illustrates an example in which the AI agent has returned the result 802 and next IGA next step 804 (e.g., “View Search Workflow here”) and the user has selected to view the workflow such that a graphical model of the workflow 902 appears in the user's browser or other desktop application with which the AI agent is integrated.

In some embodiments, a feedback loop is implemented. The feedback loop comprises elements of telemetry, analysis and update. Using the (1) telemetry, the system captures the user's direct response and any feedback (sentiment value or feedback comments) they may have to responses provided by the AI system. Such data is (2) analyzed and categorized into existing workflows, e.g. updating the workflow builder or updating the admin search component. The user's intent as “query” and “expected results” can also be distilled, which go into evaluation test cases. The test cases can be analyzed to (4) update prompts, either manually or using machine learning, to improve results on previous and new test cases. For example, the feedback may be used to update the examples used for few-shot learning.

### System Architecture and Hardware Componentry

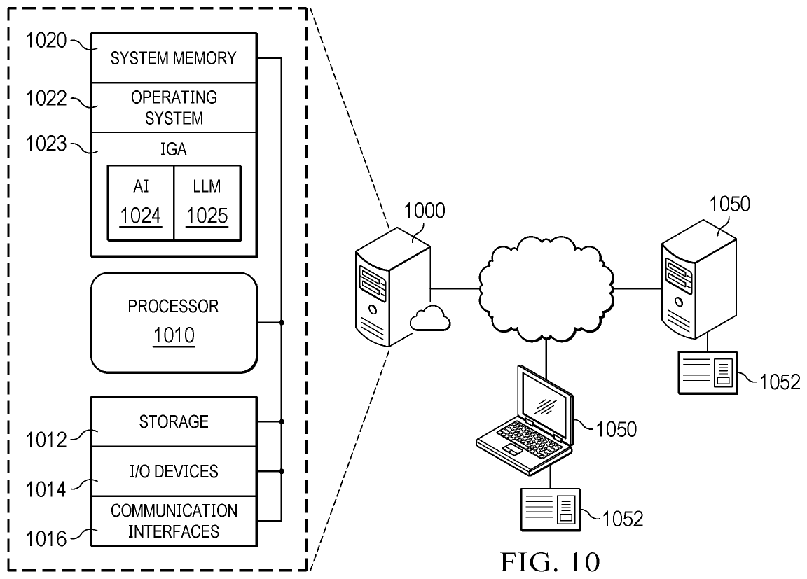

FIG. 10 illustrates one embodiment of an IGA computer system 1000. Computer system 1000 includes a processor 1010 and memory 1020. Depending on the exact configuration and type of computing device, memory 1020 (storing, among other things, executable instructions) may be volatile (such as RAM), non-volatile (such as ROM, flash memory, etc.), or some combination of the two. Further, computer system 1000 may also include storage devices 1012, such as, but not limited to, solid state storage. Similarly, computer system 1000 may also have input device(s) and output device (I/O devices 1014) such as keyboard, mouse, pen, voice input, touch screen, and speakers. Computer system further includes communications interfaces 1016, such as a cellular interface, a Wi-Fi interface, or other interfaces.

Computer system 1000 includes at least some form of non-transitory computer-readable media. The non-transitory computer-readable media can be any available media that can be accessed by processor 1010 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 1020. While executing on processor 1010, program modules (e.g., applications, Input/Output (I/O) management, and other utilities) may perform processes including, but not limited to, one or more of the stages of the operational methods described with respect to AI agents. In one embodiment, system memory 1020 stores an operating system 1022 and IGA application 1023 that includes AI agent code 1024 executable to use an LLM 1025 to perform one or more operations. In one embodiment, AI agent code 1024 is executable to perform one or more steps of flow 100, flow 200, or flow 300. While illustrated as a component of computer system 1000, LLM 1025 may be provided by a remote system, such as by a third-party LLM provider.

Computer system 1000 may be a cloud computing system in some embodiments. Computer system 1000 can connect over a network (e.g., LAN, WAN, the Internet or combinations thereof) to client computers 1050 that run IGA clients 1052. The IGA clients, according to one embodiment, are web browsers that run browser-based applications for interacting with IGA application 1023. IGA clients 1052 can implement UIs for AI agents and other components.

### Exemplary Prompt Data and Code Objects

The following section provides examples of prompt data, use cases, and configurations for various supported identity governance tools, such as an administrative search tool, a workflow builder tool, a documentation retrieval tool, and a fallback tool. This data may be included in engineered prompts sent to the large language model (LLM) to facilitate few-shot learning. By providing these examples in the prompt, the AI agent enables the LLM to accurately evaluate a user's natural language query and determine the appropriate internal tool to execute the request. It should be understood that these are merely illustrative examples, and the system is not limited to these specific tools, use cases, or configurations.

### **Purpose:**

admin_search tool converts user's text queries into ElasticSearch queries. The user queries could be related to identities, roles, entitlements, privileges, access profiles, audit events, and administrative information. This tool provides the data via the identity platform.
Examples of user queries and admin_search queries are:
<examples>
user_query: “How many identities belong to Engineering department”?
Answer: Let's think step-by-step. The questions asks about the number of identities that belong to a department. Since the user wants to directly search information on identity without knowing about the process or how-to, admin_search tool should be used to answer user's question. Therefore, output should be:
tool: admin_search
query: Find all identities with a custom attribute ‘department’ equal to ‘Engineering’
user_query: “Tell me about identities under John Doe”?
Answer: Let's think step-by-step. The questions asks information on identities to a specific entity. Since the user wants to directly search information on identities without knowing about the process or how-to, admin_search tool should be used to answer user's question. Therefore, output should be:
tool: admin_search
query: Tell me about identities under John Doe
<end-of-examples>
*Key use cases for admin_search tool:**
*Translating natural language queries into lucene query
*limitations:**
*Does not answer questions about how to use admin search tool
*Does not provide descriptive answers or examples

### **Purpose:**

workflow_builder tool creates workflows in the Sailpoint IdentityNow platform. The tool returns a pointer (id) to the newly created workflow. A workflow is a set of steps that are completed every time a specific event occurs and automatically performs a series of actions within system that lets you configure a response to a trigger.
Workflow builder example:
<examples>
user_query: I want to build a workflow that will send email to all new hires in Sales Department
Answer: Let's think step-by-step. The user requires your help to create a workflow that will send email to all new hires in a particular department. Since the user wants to create workflow directly without enquiring about steps on how-to generate workflow, workflow_builder tool must be used to answer user's question. Therefore, output should be:
tool: workflow_builder
query: Create a workflow that sends an email to new hires in the Sales department
user_query: Create a workflow with role based filters to set-up a new certification campaign
Answer: Let's think step-by-step. Since user is asking to create a new workflow with filters for a task that is specific to sailpoint, workflow_builder should be used.
tool: workflow_builder
query: Create a workflow with role based filters to set-up a new certification campaign
<end-of-examples>
*Key use case for workflow_builder:**
*Create workflows based on user specifications
*limitations:**
*Does not answer questions about how to use workflow tool
*Does not provide descriptive answers or examples of workflow took itself
*Does not update or modify existing workflows

### **Purpose:**

sailpoint_doc is a tool that provides information about Sailpoint's product. It has access to the knowledge base component which stores publicly available information about Sailpoint, its product and tools. This tool can answer user's query related to errors from SailPoint products and tools. The documentation contains information on a few Sailpoint's products:
   Identity Security Cloud (ISC) which is the SaaS offering of Sailpoint including the following modules:
   *SailPoint Cloud Infrastructure Entitlement Management (CIEM) to govern enterprise cloud entitlements
   *Access Risk Management (ARM) to predict SoD access risks and simplify GRC
   *Non-Employee Risk Management (NERM) to manage risks associated with non-employees
   *Data Access Security (DAS) to discover, govern, and secure unstructured data
   *IdentityNow (IDN) to manage and govern identities and their access
   *AI-Driven Identity Security to make smarter decisions with AI
   *SaaS Management to uncover shadow IT and SaaS access risk
   *Cloud Access Management (CAM) to discover and protect access
   The ISC is the biggest offering. Other products include:
   *IdentityIQ (IIQ) which is the on-prem offering of Sailpoint including the following modules. Currently, sailpoint_doc tool is capable of answering limited questions on IIQ. It is only aware of what IIQ is.
   *Connectors and integrations to connect to various systems
   *Sailpoint Customer Agreements Definitions
The sailpoint_doc tool also provides documentation and guidance on how to use SailPoint's product tools and features such as Admin Search Tool and Workflows Builder
sailpoint_doc tool examples:
<examples>
user_query: What is ISC?
Answer: Let's think step-by-step. The question asks about ISC which is one of the products offered by SailPoint. Since user is asking about the product, sailpoint_doc should be used to answer user's question. Therefore, output should be:
tool: sailpoint_doc
query: What is ISC?
user_query: What is the process to manage user access?
Answer: Let's think step-by-step. The question asks about process on managing a user's access. Since it is related to SailPoint's product, sailpoint_doc should be used to answer user's question. Therefore:
tool: sailpoint_doc
query: What is the process to manage user access?
user_query: How can I get identities with access to an entitlement?
Answer: Let's think step-by-step. The user wants to know the process on how to get identities with access to any entitlement. Since user's query is interrogating the process about finding identities, sailpoint_doc tool must be used to answer user's question. Therefore, output should be:
tool: sailpoint_doc
query: How can I get identities with access to an entitlement?
user_query: How to find out number of identities reporting to John Doe?
Answer: Let's think step-by-step. The user wants to know the process on how to find number of identities reporting to John Doe. Since user's query is interrogating the process about finding identities reporting to a particular identities, sailpoint_doc tool must be used to answer user's question. Therefore, output should be:
tool: sailpoint_doc
query: How to find out number of identities reporting to John Doe?
<end-of-examples>
*Key use cases of sailpoint_doc tool:**
*Answer domain-related questions that do not require running any tool directly
*Answer “how-to” questions about other tools (e.g “How to use admin search tool?” or “how to update workflows?”)
*Provide examples or guidance on how to use SailPoint's products, features and tools including workflow builder and admin search tools
*Knowledge and instructions that do not require running the tool itself
**Limitations:**
*Does not replace tool outputs. For example, while it can explain how to use workflow tool but it cannot generate workflows itself
*Not suitable for direct data-related outputs: It cannot process or analyze data, create text to queries, or generate workflows
*Does not know specific processes (“how-to”) for IIQ

### **Purpose:**

This is a general tool that serves 2 purposes:
1. It rejects queries in situations listed below:
   a. when queries are either unethical
   b. task is irrelevant to SailPoint's domain
   c. task involves looking up user's personal data
   d. execution task not supported by either admin_search or workflow_builder
   In the above situations fallback_tool tool returns a polite message to inform user that their ask is out of scope of AI Agent.
   Make sure to reject queries that has abusive language or anything that harms SailPoint's reputation.
2. It answers general queries that do not require SailPoint specific information. In this situation, the message should have generic information to answer the user. Chat history or general facts can be used to answer the user, however, the facts must not be made up.
<examples>
user_query: What is weather in July in Southern Ontario, Canada?
Answer: Lets think this step-by-step. The user has asked a general question that has no relation to SailPoint domain. Therefore, reply from fallback_tool tool to user could include some facts about weather in July in Southern Ontario.
tool: fallback_tool
Query: What is weather in July in Southern Ontario, Canada?
user_query: Where did identity John Doe attend their school
Answer: Lets think this step-by-step. The user has asked a question about a random person John Doe. Think if they are popular person. Since John Doe is a random person whose information is not available and we tend not to reveal any personal information about them such as school or work history, reject user's query and refrain from answering about John Doe.
tool: fallback_tool
reject_flag: True
user_query: Search all emails sent to me by admin.
Answer: Let's think this step-by-step. The user has asked to search personal email box. Since no other tool supports answering queries with personal information, reject user's query and refrain from answering.
tool: fallback_tool
reject_flag: True
user_query: I want a workflow to sail a ship out of shipyard.
Answer: Let's think this step-by-step. The user has asked for workflow about a task that is irrelevant to SailPoint. Even though SailPoint has a workflow builder, task is irrelevant and should be rejected.
tool: fallback_tool
reject_flag: True
user_query: Update this workflow to send me a success email after all triggers are completed
Answer: Let's think step-by-step. The user wants to update an existing workflow. Unfortunately, workflow_builder is not able to update workflows. Since this task is about execution that is not yet supported, reject this query from user.
tool: none_selected
reject_flag: True
user_query: In my workflow, add a step for data validation
Answer: Let's think step-by-step. The user wants to modify their existing workflow by adding a data validation step. Unfortunately, workflow_builder is not able to update workflows. Since this task is about execution that is not yet supported, reject this query from user.
tool: none_selected
reject_flag: True
<end-of-examples>

The following quoted paragraph details an example embodiment of a prompt template utilized by the system's workflow builder tool. This template is used to generate an engineered prompt that supplies the large language model (LLM) with necessary instructions, system context, and few-shot learning examples. This forces the LLM to analyze the relevant identity governance documentation and generate the most appropriate workflow code object based on the user's natural language question. This template is merely an illustrative example, and the system's prompt engineering is not limited to this specific format, wording, or content.
“You are a workflows expert at CompanyName. Your job is to take a plain text message and turn it into a workflow JSON object that can be uploaded to the workflow endpoint. Given the following verified sources and a question, create a json object that represents the workflow.”

The following section illustrates an example embodiment of an initial code object, specifically an initial workflow defined as a JavaScript Object Notation (JSON) object. This structure represents an example of an initial, unrefined code generated by the large language model (LLM) interacting with the identity governance system APIs, which is subsequently passed into the recursive workflow builder to be split into discrete steps and evaluated against validation rules. It is to be understood that this initial code object is merely an illustrative example, and the invention is not limited to this specific JSON structure, workflow definition, or syntax.

```
{
  “name”: “Email Notification for New Admin User”,
  “description”: “Sends an email when a new user is created with admin privileges”,
  “definition”: {
    “start”: “Get Identity”,
    “steps”: {
      “Get Identity”: {
        “actionId”: “sp:get-identity”,
        “attributes”: {
          “id.$”: “$.trigger.identity.id”
        },
        “displayName”: “Get Identity Details”,
        “nextStep”: “Check Admin Access”,
        “type”: “action”,
        “versionNumber”: 2
      },
      “Check Admin Access”: {
        “actionId”: “sp:compare-strings”,
        “attributes”: {
          “variableA.$”: “$.getIdentity.attributes.assignedGroups”,
          “comparator”: “StringContains”,
          “variableB”: “ORG_ADMIN”
        },
        “displayName”: “Check for Admin Privileges”,
        “nextStep”: “Send Email”,
        “type”: “choice”,
        “choiceList”: [
          {
            “comparator”: “StringContains”,
            “nextStep”: “Send Email”,
            “variableA.$”: “$.getIdentity.attributes.assignedGroups”,
            “variableB”: “ORG_ADMIN”
          }
        ],
        “defaultStep”: “End Step - Success”
      },
      “Send Email”: {
        “actionId”: “sp:send-email”,
        “attributes”: {
          “body”: “A new user with admin privileges has been created:\n\nName: $
{name}\nEmail: ${email}\n\nPlease review this account to ensure it was created
appropriately.”,
          “context”: {
            “name.$”: “$.getIdentity.name”,
            “email.$”: “$.getIdentity.email”
          },
          “recipientEmailList”: [“security@example.com”],
          “subject”: “New Admin User Created”
        },
        “displayName”: “Send Notification Email”,
        “nextStep”: “End Step - Success”,
        “type”: “action”,
        “versionNumber”: 2
      },
      “End Step - Success”: {
        “displayName”: “End”,
        “type”: “success”
      }
    }
  },
  “trigger”: {
    “type”: “EVENT”,
    “attributes”: {
      “id”: “idn:identity-created”
    }
  }
}
```

The following section illustrates an example embodiment of a final, fully validated code object, specifically a final workflow defined as a JavaScript Object Notation (JSON) object. This structure represents the refined and completed code output after the recursive workflow builder has systematically evaluated and corrected any validation errors in the individual discrete steps, resulting in a functional identity governance workflow ready for execution. This final code object is provided merely as an illustrative example, and the system's output is not limited to this specific configuration, logical sequence, or code structure.

```
{
    “definition”: {
      “start”: “Get Identity”,
      “steps”: {
        “Check Admin Access”: {
          “actionId”: “sp:compare-strings”,
          “attributes”: {
            “comparator”: “StringContains”,
            “variableA.$”: “$.getIdentity.attributes.assignedGroups”,
            “variableB”: “ORG_ADMIN”
          },
          “choiceList”: [
            {
              “comparator”: “StringContains”,
              “nextStep”: “Send Email”,
              “variableA.$”: “$.getIdentity.attributes.assignedGroups”,
              “variableB”: “ORG_ADMIN”
            }
          ],
          “defaultStep”: “End Step - Success”,
          “displayName”: “Check for Admin Privileges”,
          “nextStep”: “Send Email”,
          “type”: “choice”
        },
        “End Step - Success”: {
          “displayName”: “End”,
          “type”: “success”
        },
        “Get Identity”: {
          “actionId”: “sp:get-identity”,
          “attributes”: {
            “id.$”: “$.trigger.identity.id”
          },
          “displayName”: “Get Identity Details”,
          “nextStep”: “Check Admin Access”,
          “type”: “action”,
          “versionNumber”: 2
        },
        “Send Email”: {
          “actionId”: “sp:send-email”,
          “attributes”: {
            “body”: “A new user with admin privileges has been created:
\n\nName: ${name}\nEmail: ${email}\n\nPlease review this account to ensure it was
created appropriately.”,
            “context”: {
              “email.$”: “$.getIdentity.email”,
              “name.$”: “$.getIdentity.name”
            },
            “from”: “notifications@example.com”,
            “recipientEmailList”: “security@example.com”,
            “replyTo”: “no-reply@example.com”,
            “subject”: “New Admin User Created”
          },
          “displayName”: “Send Notification Email”,
          “nextStep”: “End Step - Success”,
          “type”: “action”,
          “versionNumber”: 2
        }
      }
    },
    “description”: “Sends an email when a new user is created with admin
privileges”,
    “name”: “Email Notification for New Admin User”,
    “trigger”: {
      “attributes”: {
        “id”: “idn:identity-created”
      },
      “type”: “EVENT”
    }
  }
```

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner or even removed or rendered as inoperable in certain cases, as is useful in accordance with a particular application. Additionally, any signal arrows in the drawings/figures should be considered only as exemplary, and not limiting, unless otherwise specifically noted.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Appendices. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method for operating an identity governance artificial intelligence (AI) agent, the method comprising:
receiving, via a user interface, a natural language prompt from a user to perform an identity governance operation;
processing the natural language prompt using a large language model (LLM) to generate an initial code object for executing the identity governance operation;
splitting the initial code object into a plurality of discrete steps;
evaluating a first discrete step of the plurality of discrete steps against step-specific validation rules to determine whether the first discrete step is valid;
responsive to determining that the first discrete step is invalid based on a validation error, automatically generating a revised prompt comprising the invalid first discrete step, the validation error, and contextual information from the initial code object;
transmitting the revised prompt to the LLM to generate an updated first discrete step; and
iteratively evaluating and updating the first discrete step until valid, and combining the valid first discrete step with other valid discrete steps of the plurality of discrete steps to output a fully validated code object for the identity governance operation.

2. The method of claim 1, wherein the initial code object and the fully validated code object are formatted as JavaScript Object Notation (JSON) objects.

3. The method of claim 1, wherein the identity governance operation comprises generating a workflow.

4. The method of claim 1, wherein processing the natural language prompt using the LLM further comprises automatically selecting a workflow builder tool from a plurality of available identity governance tools based on an intent of the natural language prompt.

5. The method of claim 1, wherein the contextual information from the initial code object included in the revised prompt comprises adjacent discrete steps that are dependent on the first discrete step.

6. The method of claim 1, further comprising: prior to splitting the initial code object, applying core validation rules to the initial code object to determine whether an overall structure of the initial code object is valid; and responsive to determining the overall structure is invalid, prompting the LLM to correct the overall structure.

7. The method of claim 1, further comprising: determining, based on the fully validated code object, a subsequent identity governance operation to be performed; and providing, for display on the user interface, an option to execute the subsequent identity governance operation.

8. An identity governance computer system comprising:
one or more processors; and
a non-transitory computer-readable memory storing instructions that, when executed by the one or more processors, cause the identity governance computer system to perform operations comprising:
receiving, via a user interface, a natural language prompt from a user to perform an identity governance operation;
processing the natural language prompt using a large language model (LLM) to generate an initial code object for executing the identity governance operation;
splitting the initial code object into a plurality of discrete steps;
evaluating a first discrete step of the plurality of discrete steps against step-specific validation rules to determine whether the first discrete step is valid;
responsive to determining that the first discrete step is invalid based on a validation error, automatically generating a revised prompt comprising the invalid first discrete step, the validation error, and contextual information from the initial code object;
transmitting the revised prompt to the LLM to generate an updated first discrete step; and
iteratively evaluating and updating the first discrete step until valid, and combining the valid first discrete step with other valid discrete steps of the plurality of discrete steps to output a fully validated code object for the identity governance operation.

9. The identity governance computer system of claim 8, wherein the initial code object and the fully validated code object are formatted as JavaScript Object Notation (JSON) objects.

10. The identity governance computer system of claim 8, wherein the identity governance operation comprises generating a workflow.

11. The identity governance computer system of claim 8, wherein the operations further comprise automatically selecting a workflow builder tool from a plurality of available identity governance tools based on an intent of the natural language prompt.

12. The identity governance computer system of claim 8, wherein the contextual information from the initial code object included in the revised prompt comprises adjacent discrete steps that are dependent on the first discrete step.

13. The identity governance computer system of claim 8, wherein the operations further comprise: prior to splitting the initial code object, applying core validation rules to the initial code object to determine whether an overall structure of the initial code object is valid; and responsive to determining the overall structure is invalid, prompting the LLM to correct the overall structure.

14. The identity governance computer system of claim 8, wherein the operations further comprise: determining a subsequent identity governance operation to be performed; and
providing, for display on the user interface, a selectable option to execute the subsequent identity governance operation.

15. A non-transitory computer-readable medium storing instructions that, when executed by one or more processors of an identity governance computer system, cause the identity governance computer system to perform operations comprising:
receiving, via a user interface, a natural language prompt from a user to perform an identity governance operation;
processing the natural language prompt using a large language model (LLM) to generate an initial code object for executing the identity governance operation;
splitting the initial code object into a plurality of discrete steps;
evaluating a first discrete step of the plurality of discrete steps against step-specific validation rules to determine whether the first discrete step is valid;
responsive to determining that the first discrete step is invalid based on a validation error, automatically generating a revised prompt comprising the invalid first discrete step, the validation error, and contextual information from the initial code object;
transmitting the revised prompt to the LLM to generate an updated first discrete step; and
iteratively evaluating and updating the first discrete step until valid, and combining the valid first discrete step with other valid discrete steps of the plurality of discrete steps to output a fully validated code object for the identity governance operation.

16. The non-transitory computer-readable medium of claim 15, wherein the initial code object and the fully validated code object are formatted as JavaScript Object Notation (JSON) objects.

17. The non-transitory computer-readable medium of claim 15, wherein the identity governance operation comprises generating a workflow.

18. The non-transitory computer-readable medium of claim 15, wherein the operations output the fully validated code object in response to a single natural language prompt from the user without intervening user input.

19. The non-transitory computer-readable medium of claim 15, wherein the contextual information from the initial code object included in the revised prompt comprises adjacent discrete steps that are dependent on the first discrete step.

20. The non-transitory computer-readable medium of claim 15, wherein the operations further comprise: prior to splitting the initial code object, applying core validation rules to the initial code object to determine whether an overall structure of the initial code object is valid; and responsive to determining the overall structure is invalid, prompting the LLM to correct the overall structure.
